(19) United States
(12) Patent Application Publication
(10) Pub. No.: US 2023/0093618 A1
(43) Pub. Date: Mar. 23, 2023

(54) METHODS AND APPARATUS FOR DISPOSABLE CHARGING LABEL

(71) Applicant: Creative Destruction Technologies, LLC, Chandler, AZ (US)

(72) Inventors: William Robert Peterson, III, Huntington Beach, CA (US); Vincent B. Adam, Chandler, AZ (US)

(21) Appl. No.: 17/946,427

(22) Filed: Sep. 16, 2022

Related U.S. Application Data
(60) Provisional application No. 63/245,536, filed on Sep. 17, 2021.

(51) Int. Cl. H02J 50/10; H02J 50/00

(52) U.S. Cl. CPC H02J 50/10; H02J 50/005

(57) ABSTRACT

A disposable charging label according to various aspects of the present technology may comprise a thin light-weight flexible wireless charging device. The disposable charging label may comprise a pre-charged battery device and a planar coil that can be used to charge the battery of a second device positioned adjacent to the planar coil. The disposable charging label may be configured to be temporarily attached to the second device during the charging process to allow hands free operation.

### CROSS-REFERENCES TO RELATED APPLICATIONS

This application is a continuation-in-part application of U.S. Provisional Patent Application No. 63/245,536, filed on Sep. 17, 2021, and incorporates the disclosure of the application by reference.

### BACKGROUND OF THE TECHNOLOGY

Portable electronics such as smart phones, tablet computers, and other personal devices provide users with many features without being tied to a wired connection. Battery life is a limiting factor with these devices and users are faced with various obstacles when battery life gets low for a given device. Charging cords and portable charging blocks are two options but are not always the most convenient option available. For example, unless a user has access to a wall outlet a charging cord provides little benefit. Even when there is an available outlet, there are times when multiple people are each waiting for access to the outlet. Although a portable charging block may solve the problem of access, they are often heavy and can be bulky to carry around on a regular basis. In addition, because these devices contain flammable materials they often cannot be placed in baggage compartments of aircraft. Each of these options also require the user to constantly carry around a cord, which may not be convenient.

Wireless charging solutions, such as Qi chargers, have addressed the need to carry around a charging cord that is configured to work with a given device, but they too have their drawbacks. For example, most wireless charging solutions have to be plugged into an electrical outlet for power. Although a cord isn't required to charge the device, the user still needs access to electrical power. In addition, publicly available options may run into the problem of too many users for too few charging points. Wireless chargers may also be found in vehicles, but these too require a power source.

A common issue with all of the mentioned options is that charging the device requires the device be tied to the charging option. Either the device has to be left at the charging location for a sufficient amount of time for the device to receive a desired level of charge, or, in the case of a portable charging block, the device must remain physically connected to the block for an amount of time. Each of these options may be inconvenient at times and leave the user stuck in a location waiting for their device to charge.

### SUMMARY OF THE TECHNOLOGY

A disposable charging label according to various aspects of the present technology may comprise a thin light-weight flexible wireless charging device. The disposable charging label may comprise a pre-charged battery device and a planar coil that can be used to charge the battery of a second device positioned adjacent to the planar coil. The disposable charging label may be configured to be temporarily attached to the second device during the charging process to allow hands free operation.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1A representatively illustrates a user device in accordance with an exemplary embodiment of the present technology;

FIG. 1B representatively illustrates a user device with a charging system attached in accordance with an exemplary embodiment of the present technology;

FIG. 2 representatively illustrates a first embodiment of the charging system shown in FIG. 1B in accordance with an exemplary embodiment of the present technology;

FIG. 3 representatively illustrates a second embodiment of the charging system shown in FIG. 1B in accordance with an exemplary embodiment of the present technology;

FIG. 4 representatively illustrates an alternative embodiment of the charging system shown in FIG. 1B having a solar panel in accordance with an exemplary embodiment of the present technology; and

FIG. 5 representatively illustrates an extendible socket attachment with the charging system in accordance with an exemplary embodiment of the present technology.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various materials, finishes, dimensions, and geometries, which may carry out a variety of operations suited to a specified application or environment. In addition, the present technology may be practiced in conjunction with any number of systems configured for operation with rechargeable battery systems, and the system described is merely one exemplary application for the technology. Further, the present technology may employ any number of conventional techniques for connecting, attachment, and wireless charging.

Methods and apparatus for a disposable charging system according to various aspects of the present technology may operate in conjunction with any type of battery operated device that is capable of having its battery being charged wirelessly. Various representative implementations of the present technology may be applied to mobile phones, portable computing devices, personal electronics (e.g., fitness trackers, e-readers, watches, etc.), and the like.

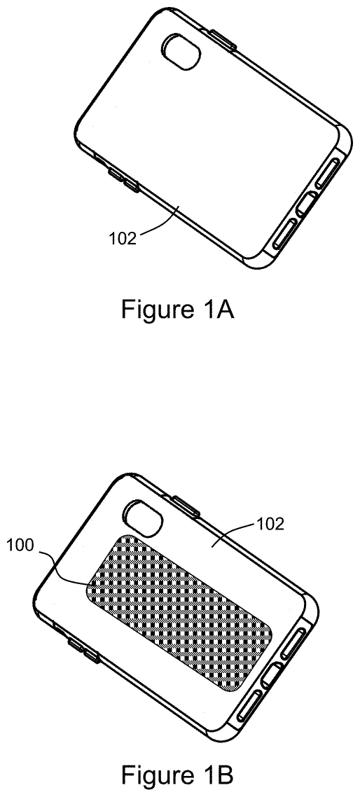

Referring to FIGS. 1A and 1B, a disposable charging system 100 in accordance with the present technology may provide a lightweight portable wireless charging system that is configured to provide a set amount of charging capacity without the negative impacts described above. The disclosed system may be disposable and configured for a single one-time use thereby allowing the user to charge their device and discard the charging system 100 once completed. Alternatively, the disclosed technology may allow for the device to be reusable. The disclosed system may also be configured to be used with the electronic device without significantly impacting its use or being overtly noticeable. For example, in one embodiment, and with particular reference to FIG. 1A, a typical user device such as a smart phone 102 may have a rear facing surface 104 that is generally smooth and undisturbed except for one or more cameras 106 positioned along the surface.

In the event that the smart phone 102 requires charging, and referring now to FIG. 1B, the disposable charging system 100 may be temporarily affixed to the rear facing surface 104. Once in place, the disposable charging system 100 may begin to charge the smart phone 102. The disposable charging system 100 may comprise a system that is lightweight and maintains a low profile that can be affixed or otherwise coupled to the smart phone 102 to recharge the device's battery and then be removed once the charging process has been completed. Throughout the charging process, the disposable charging system 100 may be connected to the device without impacting the function of the device. To the user, the device will generally look and feel the same except that its battery is being charged.

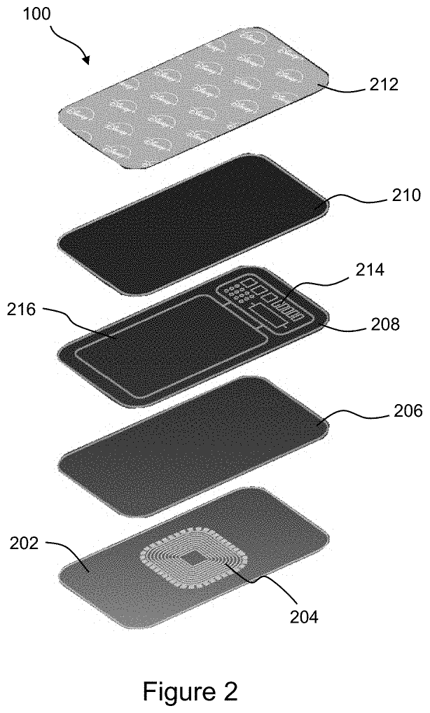

Referring now to FIG. 2, the disposable charging system 100 may generally comprise a coil layer 202 having at least one planar transmitting coil 204 disposed on a surface of the coil layer 202. A back layer 206 may be positioned between the coil layer 202 and an electronics layer 208 configured to generate an inductive current provided to the planar transmitting coil 204. The back layer 206 may be used to help direct a magnetic field generated by the electronics layer 208 in a desired direction. A cover 212 may be positioned over the electronics layer 208. The disposable charging system 100 may also comprise a thermal protection layer 210 disposed between the electronics layer 208 and the cover 212 to reduce heat transmission to the cover 212 during use.

The disposable charging system 100 may comprise any suitable dimensions and may be selected according to a desired use. For example, in one embodiment, the disposable charging system 100 may be configured for use with mobile phones and have exterior dimensions of between about 1-3 inches in width by about 2-7 inches in length.

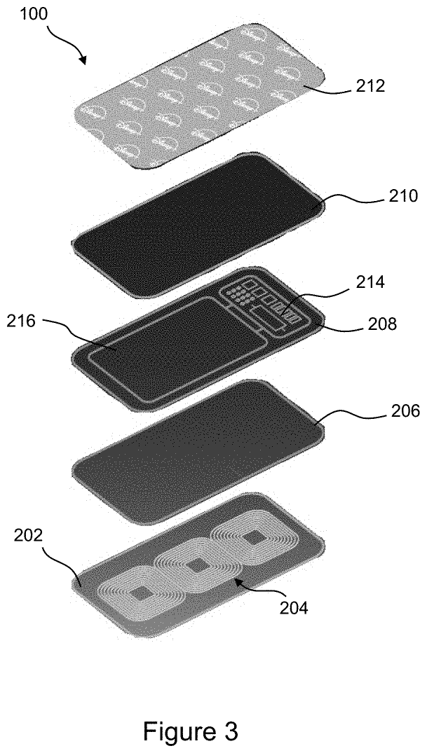

The planar transmitting coil 204 may comprise any type of electromagnetic wire coil capable of creating a magnetic field in response to an applied current through the wire. In one embodiment, the planar transmitting coil 204 may comprise a single wire coil formed in a flat plane and positioned along a portion of the coil layer 202. For example, the planar transmitting coil 204 may be located at a center location of the coil layer 202 as shown in FIG. 2. Alternatively, the planar transmitting coil 204 may be positioned at any desired location in the coil layer 202. In an alternative embodiment, and referring now to FIG. 3, the planar transmitting coil 204 may comprise a series of overlapping coils distributed over a larger area of the coil layer 202.

The electronics layer 208 may comprise a circuit board 214 having a microcircuit, one or more sensors, and a battery 216. The electronics layer 208 comprise a flexible substrate formed of any nonconductive material such as a nonconductive plastic. For example, the flexible substrate may comprise polyamide and/or polybutylene terephthalate. The circuit board 214 may be printed onto or otherwise positioned on at least one surface of the substrate. The circuit board 214 may be electrically coupled to the planar transmitting coil 204 and be configured to direct a current from the battery 216 to the planar transmitting coil 204.

The battery 216 provides power to circuit board 214 to generate the current. In some embodiments, the battery 216 may comprise any thin film, flexible, or printed battery cell that may allow for safe transmission of power to the electronic components without risk of fire. For example, the battery 216 may comprise advanced lithium-ion batteries, solid-state batteries, nickel-cadmium batteries, micro-batteries, stretchable batteries, thin flexible supercapacitors, or a manganese dioxide-based battery. The battery 216 may also be configured with an extended life to account for periods of storage prior to use. For example, the circuit board 214 may be configured to reduce power requirements by using a deep sleep mode to conserve the available amount of available battery charge capacity for as long as possible.

When the disposable charging system 100 is activated by an end user, a device power state transition system may trigger the circuit board 214 or battery 216 to automatically switch from an ultra-low power mode to an active fully functioning mode. For example, when the disposable charging system 100 is removed from its original packaging, an activation sensor may create a signal to automatically “wake” the circuit board 214 from the low power mode to a “ready” state capable of providing charging capability.

The activation sensor may trigger activation of the circuit board 214 by any suitable method. For example, the activation sensor may generate a signal that is transmitted to the circuit board 214 to “wake” the circuit board up. Alternatively, the activation sensor may trigger activation of the battery 216 by completing or closing an electrical circuit when the activation sensor senses a predetermined activation event.

The activation sensor may comprise any suitable device or element for sensing the predetermined activation event and causing the battery 216 to switch power states such as a button, a reed switch, an accelerometer, an electrical trace line, or an environmental sensor. In one embodiment, the activation sensor may comprise an ambient light detector configured to sense a change in a light condition after the disposable charging system 100 is removed from its packaging signaling that the disposable charging system 100 has entered into an active and operational state requiring full battery power.

The cover 212 may comprise any suitable device or material for sealing off the circuit board 214 or any other internal components from exposure. For example, the cover 212 may comprise a flexible polypropylene material configured to help secure the individual layers in place. The cover 212 may also comprise an exterior facing surface that may include a surface treatment. For example, in embodiment, the surface treatment may comprise a design feature such as a company logo, advertisement, or other embellishment.

An exterior facing surface of the coil layer 202 may be configured for removable attachment to the user device. The exterior facing surface of the coil layer 202 may comprise any suitable device or system for creating a selectively removable connection between the disposable charging system 100 and a user device. For example, in one embodiment the exterior facing surface of the coil layer 202 may comprise a mild adhesive material configured to allow for the temporary attachment of the exterior facing surface of the coil layer 202 to the user device. In an alternative embodiment, the exterior facing surface of the coil layer 202 may comprise one or more magnets that are configured to hold the disposable charging system 100 to the user device during use. Once charging is complete, the disposable charging system 100 can be removed and discarded or saved for continued use later if there is any remaining charge capacity.

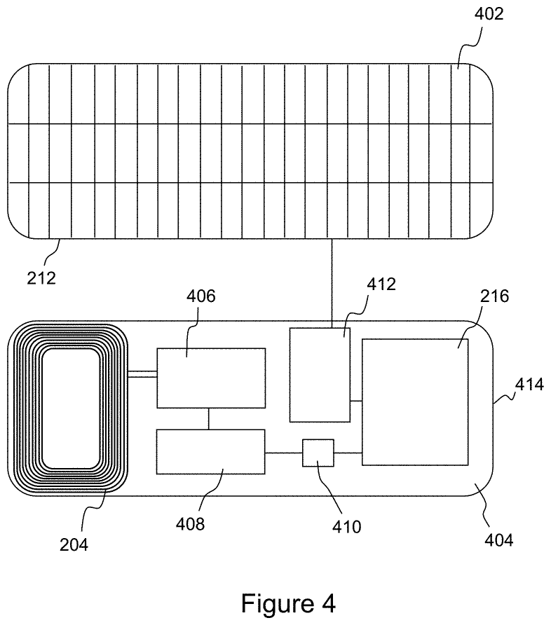

With reference now to FIG. 4, in one embodiment, the coil layer 202 and the electronics layer 208 may be combined into a single operational layer 414. For example, a switch 410 may be positioned between the battery 216 and a voltage booster 408 coupled to a Qi charger 406 to prevent a constant drain on the battery 216. The Qi charger 406 may be coupled directly to the planar transmitting coil 204 to provide the required current to generate wireless charging through the planar transmitting coil 204.

With continued reference to FIG. 4, in another embodiment, the cover 212 may comprise an element configured to recharge the battery 216 to provide a reusable charging system. For example, the surface treatment on the cover 212 may comprise a solar panel 402 having a series of solar cells that is configured to recharge the battery 216. The solar panel 402 may be electrically connected to the battery 216 by a voltage regulator 412 positioned on the circuit card 214. The solar panel 402 may comprise any suitable device such as a photovoltaic material deposited onto a flexible substrate to provide increased durability over a glass-based solar panel.

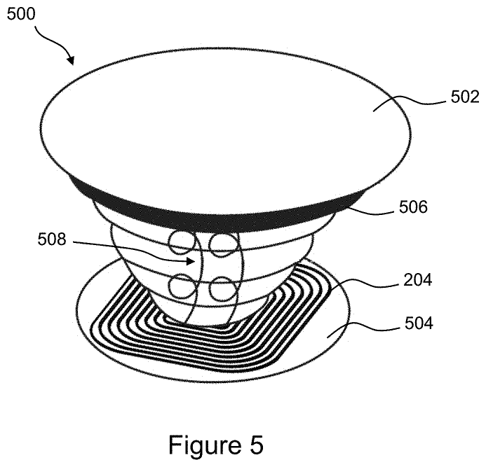

Referring now to FIG. 5, in an alternative embodiment, the charging system may be incorporated into a separate device such as an extendible holding device 500. The extendible holding device 500 may be configured to collapse and extend to improve handling of a portable electronic device such as a mobile phone or portable computing device. For example, the extendible holding device 500 may comprise a base end 504 that is configured to be attached, or otherwise connected to, the portable electronic device and a distal end 502 that is configured to move between a collapsed positioned (not shown) wherein the distal end 502 and the base end 504 are adjacent to each other and an extended positioned (see FIG. 4) wherein the distal end 502 is extended outwardly away from the base end 504.

The planar transmitting coil 204 may be integrated into the base end 504 to allow the extendible holding device 500 to charge the portable electronic device as described above. A battery and circuit board may be integrated into a pack 506 positioned proximate the distal end 502. A pair of wires 508 may electrically connect the pack 506 to the planar transmitting coil 204.

The extendible holding device 500 may be configured to be disposable as described above, or it may be configured for a more permanent attached to the portable electronic device such that the battery located in the pack 506 may be rechargeable. To facilitate recharging of the battery, the pack 506 may include a receptacle such as a USB port to allow the pack to be plugged into a charging device. Alternatively, the planar transmitting coil 204 may be configured to charge the battery when the planar 204 is positioned adjacent to a Qi charging device.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Although embodiments of the present technology have been described with reference to a batting glove, the technology should not be viewed as being limited in that respect. As would be familiar with one of ordinary skill in the art after becoming familiar with the teachings of the present technology, the subject matter could also be used with other types of handles used with rackets, golf clubs, and the like.

The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the components and/or elements recited in any apparatus embodiment may be assembled or otherwise operationally configured in a variety of permutations to produce substantially the same result as the present technology and are accordingly not limited to the specific configuration recited in the specific examples.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to exemplary embodiments. However, changes and modifications may be made to the exemplary embodiments without departing from the scope of the present technology. These and other changes or modifications are intended to be included within the scope of the present technology, as expressed in the following claims.

1. A disposable wireless charging system for a portable electronic device, comprising:
a cover layer;
an electronics layer disposed below the cover layer, comprising:
a circuit board disposed on a flexible substrate, wherein circuit board configured to create an inductive current; and
a battery electrically coupled to the circuit board;
a coil layer disposed below the electronics layer, comprising:
an exterior surface facing away from the electronics layer and configured to attach to the portable electronic device; and
a planar transmitting coil disposed along an inner facing surface of the coil layer, wherein the planar transmitting coil is configured to:
convert the inductive current from the circuit board into a magnetic field; and
direct the magnetic field to the attached portable electronic device.

2. A disposable wireless charging system according to claim 1, further comprising:
a back layer disposed between the coil layer and the electronics layer; and
a thermal layer disposed between the electronics layer and the cover layer.

3. A disposable wireless charging system according to claim 1, further comprising a sensor coupled to the circuit board and configured to generate a signal in response to a detected condition.

4. A disposable wireless charging system according to claim 3, wherein the wherein circuit board signals the battery to enter sleep mode until the sensor generates the signal in response to the detected condition.

5. A disposable wireless charging system according to claim 3, wherein the sensor comprises an accelerometer.

6. A disposable wireless charging system according to claim 3, further comprising a battery switch coupled to the battery and configured to activate the battery in response to the signal generated in response to the detected condition.

7. A disposable wireless charging system according to claim 1, wherein the battery comprises a printed battery disposed on the flexible substrate and electrically coupled to the circuit board.

8. A disposable wireless charging system according to claim 1, wherein an adhesive is disposed over at least a portion of the exterior surface of the coil layer.

9. A disposable wireless charging system according to claim 1, wherein coil layer comprises a plurality of coils positioned adjacently across the inner facing surface of the coil layer.

10. A wireless charging system for a portable electronic device, comprising:
a circuit board disposed on a flexible substrate, wherein circuit board configured to create an inductive current;
a battery electrically coupled to the circuit board; and
a coil layer disposed below the electronics layer, comprising:
an exterior surface facing away from the electronics layer and configured to attach to the portable electronic device; and
a planar transmitting coil disposed along an inner facing surface of the coil layer, wherein the planar transmitting coil is configured to:
convert the inductive current from the circuit board into a magnetic field; and
direct the magnetic field to the attached portable electronic device.

11. A wireless charging system according to claim 10, further comprising:
a cover layer;
an electronics layer disposed below the cover layer, wherein the circuit board and the battery are both disposed on the electronics layer;
a back layer disposed between the coil layer and the electronics layer; and
a thermal layer disposed between the electronics layer and the cover layer.

12. A disposable charging system according to claim 11, wherein the battery comprises a printed battery disposed on the flexible substrate and electrically coupled to the circuit board.

13. A disposable charging system according to claim 11, wherein coil layer comprises a plurality of coils positioned adjacently across the inner facing surface of the coil layer.

14. A wireless charging system according to claim 10, wherein the circuit board and the battery are both disposed on the coil layer.

15. A wireless charging system according to claim 14, further comprising:
a cover layer disposed above the coil layer; and
a solar panel disposed on an exterior facing surface of the cover layer, wherein the solar panel is electrically coupled to the circuit board.

16. A wireless charging system according to claim 15, wherein the solar panel comprises a photovoltaic material deposited onto a flexible substrate.

17. A wireless charging system according to claim 10, wherein an adhesive is disposed over at least a portion of the exterior surface of the coil layer.
